(19) United States
(12) Patent Application Publication
(10) Pub. No.: US 2023/0009361 A1
(43) Pub. Date: Jan. 12, 2023

(54) SERVICE INFORMATION MANAGEMENT SYSTEM AND METHOD

(71) Applicant: HITACHI, LTD., Tokyo (JP)

(72) Inventors: Masahiro SUGETA, Tokyo (JP); Naoki IKAWA, Tokyo (JP); Hiroyasu KATO, Tokyo (JP)

(21) Appl. No.: 17/782,203

(22) PCT Filed: Sep. 25, 2020
(86) PCT No.: PCT/JP2020/036404

§ 371 Date: Jun. 3, 2022

(30) Foreign Application Priority Data
Jan. 21, 2020 (JP) 2020-007710

(51) Int. Cl. G06Q 10/06; G06Q 50/10

(52) U.S. Cl. CPC G06Q 10/0637; G06Q 50/10

(57) ABSTRACT

To provide service information management system and method which are convenient for a user. A service information management system, which manages information on a service provided from a service provider to a service user, includes: a first service management data acquisition unit that acquires first service management data for managing a service usage state for each facility of the service user; a second service management data acquisition unit that acquires second service management data storing a service usage state for each facility; an association unit that collates the first service management data with the second service management data to associate the service usage state included in the first service management data with facility identification information included in the second service management data; and a data provision unit that provides data obtained by association of the association unit to a computer of the service user.

### TECHNICAL FIELD

The present invention relates to service information management system and method.

### BACKGROUND ART

An enterprise having facilities in many sites manually collates a ledger to manage a service usage amount for each facility with an invoice and enters the service usage amount (for example, a power consumption) in the ledger when the invoice is received from a service provider, such as an electric power company, at a timing such as monthly.

Note that a technique for evaluating energy consumptions before and after energy-saving measures in association with each other is known although not significantly related to the present invention (PTL 1).

### CITATION LIST

### Patent Literature

PTL 1: JP 2002-32438 A

### SUMMARY OF INVENTION

### Technical Problem

Typically, a data structure of the invoice managed by the service provider does not match a data structure managed by a service user. Thus, it takes time and effort to grasp a relationship between a service usage state for each facility and the invoice, and an error due to manual input also occurs in the service user.

Further, the service provider manages service usage states of facilities based on contract numbers of the facilities, respectively, but the service provider manages the service usage states of the facilities based on facility numbers of the facilities, respectively. Therefore, there are many aspects that rely on knowledge and experience of a person in charge in order to associate management data in the service provider with management data in the service user so that the work efficiency is low.

The present invention has been made in view of the above problems, and an object thereof is to provide service information management system and method that are user friendly.

### Solution to Problem

In order to solve the above problems, a service information management system according to one aspect of the present invention is a service information management system that manages information on a service provided from a service provider to a service user, the service information management system including: a first service management data acquisition unit that acquires first service management data for managing a service usage state for each facility of the service user, the first service management data being managed by a computer of the service provider; a second service management data acquisition unit that acquires second service management data storing a service usage state for each facility, the second service management data being managed by a computer of the service user; an association unit that collates the first service management data with the second service management data to associate the service usage state included in the first service management data with facility identification information included in the second service management data; and a data provision unit that provides data obtained by association of the association unit to the computer of the service user.

### Advantageous Effects of Invention

According to the present invention, it is possible to collate and associate the first service management data of the service provider with the second service management data of the service user and to provide associated data to the computer of the service user, and the usability for the service user is improved.

### BRIEF DESCRIPTION OF DRAWINGS

FIG. 1 is an explanatory diagram illustrating an outline of a function of the present embodiment.

FIG. 2 is an overall configuration diagram of an information processing system including a service information management system.

FIG. 3 is an explanatory view illustrating first service management data and second service management data.

FIG. 4 is a flowchart illustrating a process of collating the first service management data with the second service management data.

FIG. 5 is an explanatory diagram illustrating main parts of a service information management system according to a second embodiment.

FIG. 6 is a flowchart illustrating a main part of a data collation process according to a third embodiment.

FIG. 7 is an overall configuration diagram of an information processing system including a service information management system according to a fourth embodiment.

FIG. 8 is an overall configuration diagram of an information processing system including a service information management system according to a fifth embodiment.

### DESCRIPTION OF EMBODIMENTS

Hereinafter, embodiments of the present invention will be described in detail based on the drawings. A service information management system 3 according to the present embodiment includes: a first service management data acquisition unit 31 that acquires first service management data T1 for managing a service usage state for each facility of a service user, the first service management data T1 being managed by a computer 1 of a service provider; a second service management data acquisition unit 32 that acquires second service management data T2 storing a service usage state for each facility, the second service management data T2 being managed by a computer 2 of the service user; an association unit 34 that collates the first service management data T1 with the second service management data T2 to associate the service usage state included in the first service management data T1 with facility identification information included in the second service management data T2; and a data provision unit 36 that provides data T3 obtained by association of the association unit 34 to the computer 2 of the service user.

The service information management system 3 may further include an inspection unit 35 that inspects presence or absence of a predetermined abnormality for the first service management data T1 acquired by the first service management data acquisition unit 31.

The data provision unit 36 can also provide an inspection result of the inspection unit to the computer 2 of the service user.

The first service management data acquisition unit 31 can acquire the first service management data T1 from the computer 1 of the service provider by a plurality of different methods.

The inspection unit 35 can also inspect the first service management data T1 for a facility out of management of the service user as the predetermined abnormality.

The inspection unit 35 can also inspect the first service management data T1 for a power-consuming device installed away from a facility 4 as the predetermined abnormality.

The inspection unit 35 can also determine a possibility that the power-consuming device included in the facility 4 has failed or a possibility that the service provider has made an error in creating the first service management data based on the inspection result.

### First Embodiment

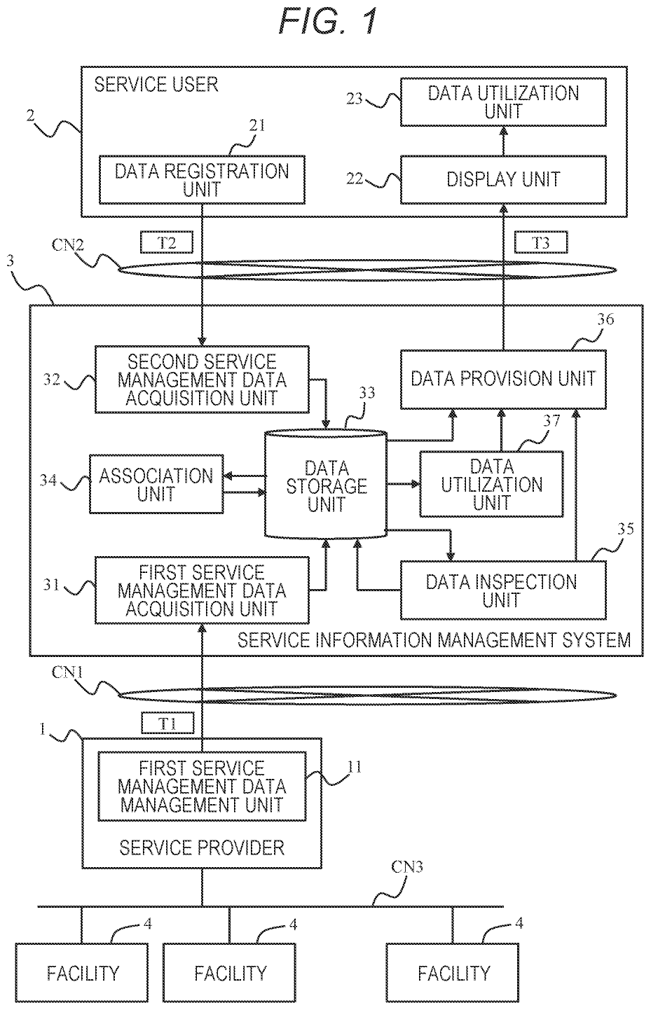

A first embodiment will be described with reference to FIGS. 1 to 4. FIG. 1 illustrates an overall outline of embodiments including the present embodiment.

The service information management system 3 is connected to the computer 1 of the service provider and the computer 2 of the service user. In the following description, there is a case where the computer 1 of the service provider is not distinguished from a service provider 1 and the computer 2 of the service user is not distinguished from a service user 2.

Although not illustrated, the service provider 1, the service user 2, and the service information management system are implemented by using one or more general-purpose computers. The general-purpose computer includes a microprocessor, a main storage device, an auxiliary storage device, a communication device, a user interface device, and the like. The auxiliary storage device stores a predetermined computer program, and the microprocessor reads and executes the predetermined computer program into a memory to implement an expected function.

The service information management system 3 and the service provider 1 are connected via, for example, a first communication network CN1. The service information management system 3 and the service user 2 are connected via a second communication network CN2. The service provider 1 and each of the facilities 4 under management of the service user 2 are connected via a third communication network CN3.

The communication networks CN1, CN2, and CN3 may be different communication networks or may be the same communication network.

The service provider 1 provides, for example, a service, such as power, gas, and water, to each of the facilities 4 of the service user 2. The service may be any service provided for each facility of the service user 2, and is not limited to a so-called infrastructure service. Hereinafter, an electric power company is described as an example of the service provider 1. The facility 4 is, for example, a store, a communication base station, or the like.

A first service management data management unit 11 of the service provider 1 manages a power consumption of each of the facilities 4 under the management of the service user. Hereinafter, the first service management data management unit 11 is referred to as the data management unit 11. The first service management data T1 managed by the data management unit 11 is acquired by the first service management data acquisition unit 31 of the service information management system 3. Here, as an example, the first service management data is power consumption data of each of the facilities 4.

The service user 2 is, for example, various companies such as a convenience store chain, a mobile communication company, a pharmacy, a post office, and a bank. The service user 2 is not limited to a private company as long as being an organization that deploys many facilities. The service user 2 may be a governmental organization.

The service user 2 includes a data registration unit 21, a display unit 22, and a data utilization unit 23.

The data registration unit 21 is a function of registering the second service management data T2 in the service information management system 3. The display unit 22 is a function of displaying data received from the service information management system 3 on a screen. The data utilization unit 23 is a function of using the data T3 received from the service information management system 3 without any change or after processing. The data utilization unit 23 can create, for example, a report for corporate social responsibility (CSR), a marketing material, an equipment update plan, a financial material, and the like. Some or all of the functions of the data utilization unit 23 may be executed by a data utilization unit 37 of the service information management system 3.

The service information management system 3 associates the first service management data T1 managed by the service provider 1 with the second service management data T2 managed by the service user 2, and provides the service user 2 with the data T3 as the associated result.

The service information management system 3 includes, for example, the first service management data acquisition unit 31, the second service management data acquisition unit 32, a data storage unit 33, the association unit 34, the data inspection unit 35, the data provision unit 36, and the data utilization unit 37.

The first service management data acquisition unit 31 is a function of acquiring the first service management data T1 from the data management unit 11 of the service provider 1. The second service management data acquisition unit 32 is a function of acquiring the second service management data T2 from the data registration unit 21 of the service user 2. The data storage unit 33 is a database that stores data.

The association unit 34 is a function of collating and associating the first service management data T1 with the second service management data T2. The data T3 as the associated result is stored in the data storage unit 33.

The data inspection unit 35, which is an example of an “inspection unit”, is a function of inspecting whether or not there is a predetermined abnormality in the first service management data T1 and storing a result of the inspection in the data storage unit 33. The data utilization unit 37 is a function of executing predetermined processing by utilizing the associated data T3. Examples of the predetermined processing include transition of an actual service usage amount, a comparison of a service usage amount with that of the same period in the previous year, prediction of a service usage amount, change of the service provider 1, and review of a service contract.

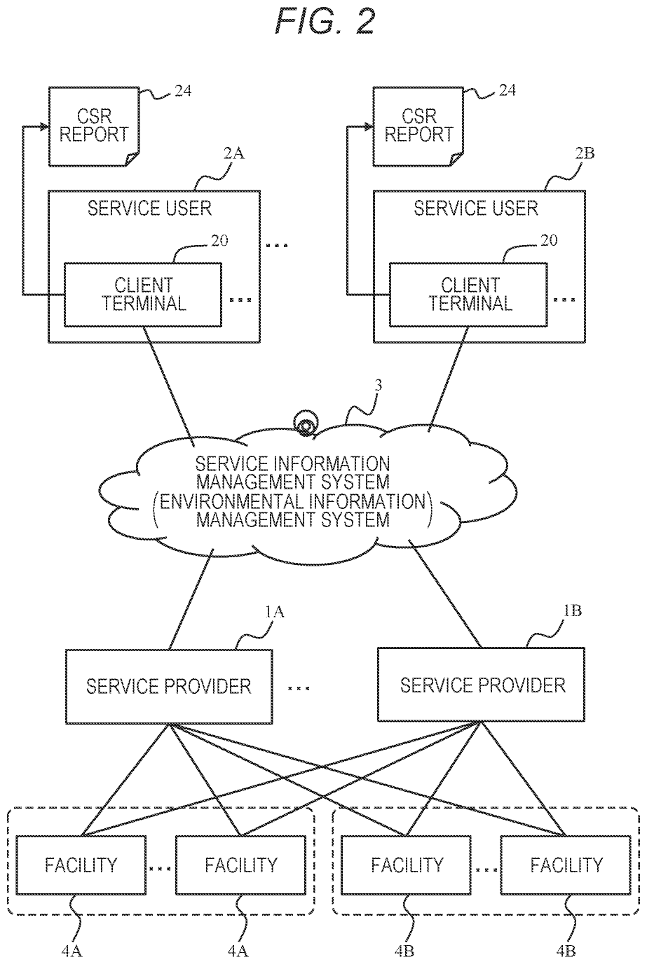

An overall configuration of an information processing system including the service information management system 3 and the like will be described with reference to FIG. 2. FIG. 2 illustrates a plurality of service providers 1A and 1B and a plurality of service users 2A and 2B.

The service users 2A and 2B may be, for example, companies in different industry types, such as a convenience store chain and a mobile communication company, or may be companies in the same industry. Hereinafter, the service users 2A and 2B are abbreviated as the service user 2 when not distinguished from one another.

The service user 2 includes at least one client terminal 20 configured to access the service information management system 3 to transmit and receive information. The client terminal 20 can implement any one, a plurality, or all of the data registration unit 21, the display unit 22, and the data utilization unit 23 described in FIG. 1. A plurality of the client terminals 20 may be configured to work in cooperation. The client terminal 20 can also be considered as an example of a “computer of a service user”. Note that the client terminal 20 can also output a product, such as a CSR report, based on data from the service information management system 3.

The service providers 1A and 1B may be, for example, companies of different industry types such as an electric power company and a gas company, or may be companies of the same industry type. When the service providers 2A and 2B are in the same industry type, the service users 2A and 2B can select which service of the service users 2A and 2B is to be used with reference to, for example, the service price, the service quality, the contribution degree to the environment, and the like.

Since the service information management system 3 can be constructed as a so-called cloud service (Software as a Service), the service users 2A and 2B can continuously receive an information processing service through the service information management system 3 regardless of which one of the service providers 1A and 1B is selected.

The service information management system 3 can also be provided as so-called on-premises in the service user 2 or the service provider 1 instead of the cloud service.

The service information management system 3 can also be regarded as a system that manages environmental information of each of the facilities 4. Examples of the environmental information include the amount of carbon dioxide discharged from the facility 4. Therefore, the service information management system 3 can also be referred to as an environmental information management system 3.

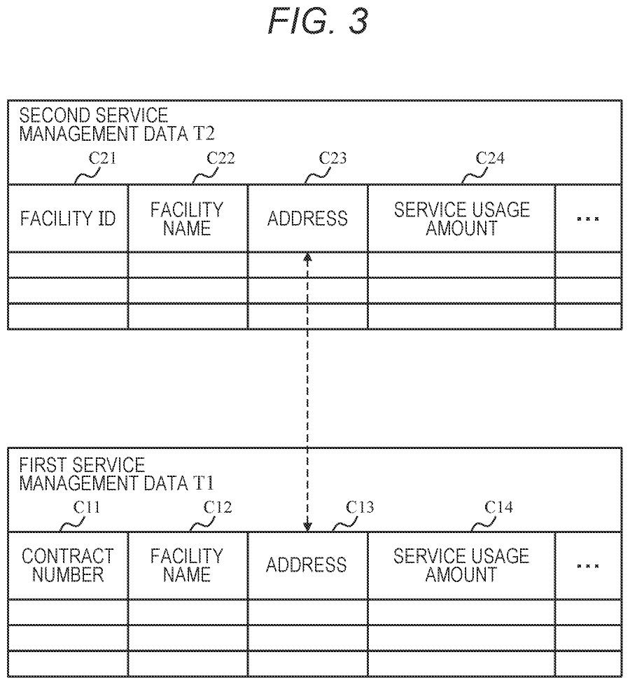

FIG. 3 is an explanatory view illustrating a relationship between the first service management data T1 and the second service management data T2.

The first service management data T1 is data for managing a service provided from the service provider 1 to the service user 2 per contract, and, for example, a contract number C11, a facility name C12, an address C13, and a service usage amount C14 are managed. Items other than the items C11 to C14 may be managed.

The second service management data T2 is data for managing a service that the service user 2 receives from the service provider 1 for each facility, and, for example, facility identification information C21, a facility name C22, an address C23 of a facility, and a service usage amount C24 are managed. Items other than the items C21 to C24 may be managed.

Here, the contract number C11 is a value set by the service provider 1 and the facility identification information C21 is a value set by the service user 2. Thus, the contract number C11 and the facility identification information C21 do not correspond to each other in an initial state illustrated in FIG. 3.

There is a possibility that the facility name C12 managed by the service provider 1 and the facility name C22 managed by the service user 2 do not match each other due to blurring of a notation, an erroneous input, a change of a facility name since the time of contract, or the like.

There is a possibility that the address C13 managed by the service provider 1 and the address C23 managed by the service user 2 do not match each other due to blurring of a notation, an erroneous input, a change of an address notation since the time of contract, or the like.

In the service usage amount C14 of the service provider 1, the amount of service used in the facility 4 is described. In the service usage amount C24 of the service user 2, a value of the corresponding service usage amount C14 is described. The service information management system 3 can also inspect a value of the service usage amount C14 charged by the service provider 1 and send a result of the inspection to the service user 2 as described later.

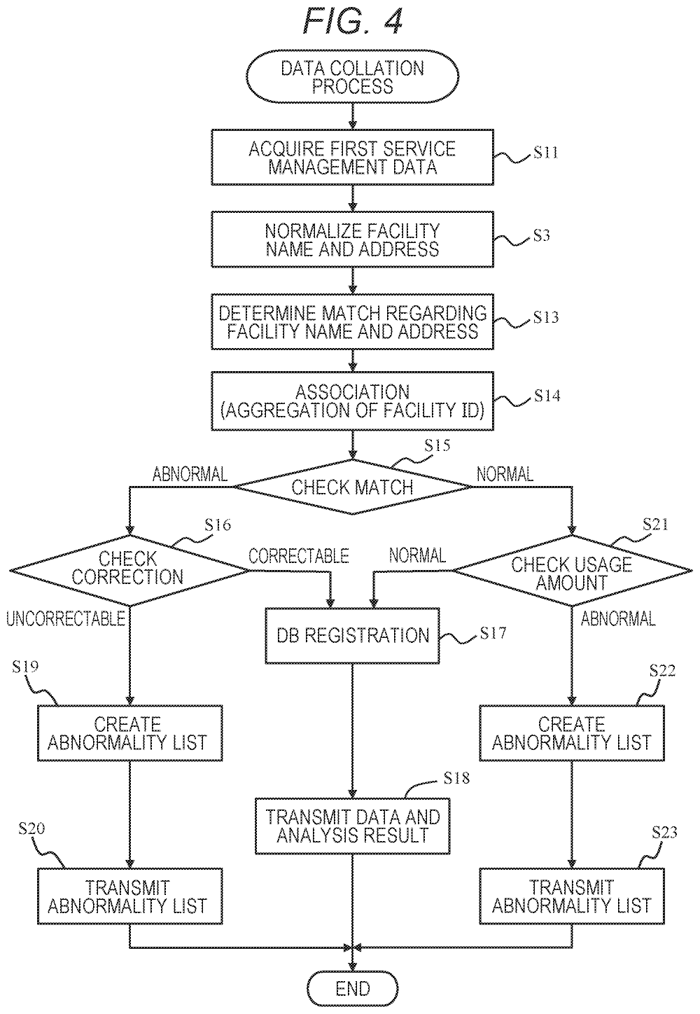

A process of collating the first service management data T1 with the second service management data T2 will be described with reference to FIG. 4.

The first service management data acquisition unit 31 of the service information management system 3 acquires the first service management data T1 from the service provider (S11). Examples of a method for acquiring the first service management data T1 from the service provider 1 include a method of receiving the first service management data T1 as electronic data from the service provider 1, a method of logging in to a web site of the service provider 1 and reading out the first service management data T1, a method of reading a form issued by the service provider 1 using an optical character recognition/reader (OCR) and acquiring the form as electronic data.

The first service management data acquisition unit 31 performs normalization processing on the facility name C12 and the address C13 of the acquired first service management data T1 (S12). The normalization processing of the facility name and address is, for example, unification of notations of numerical information (such as unification of all of various notations regarding “1”, such as one, 1, and I, to 1) and unification of address notations (for example, unification of 2-chrome 22 address to 2-22).

The association unit 34 determines a match between the first service management data T1 and the second service management data T2 for the normalized facility name and address (S13). The association unit 34 compares the facility name C12 and the address C13 of the first service management data T1 with the facility name C22 and the address C23 of the second service management data T2 as character strings, and associates the contract number C11 with the facility identification information C21 based on the degree of matching between the character strings.

The association unit 34 reads out the second service management data T2 matching the facility name and address described in the first service management data T1 from the data storage unit 33, and associates the content of the first service management data T1 with each facility identification information C21 (S14). In a case where there is no corresponding facility, the data storage unit 33 returns NULL.

The association unit 34 checks whether the facility name and address match for the second service management data T2 for which the association has been completed (S15). When the facility name and address do not match (S15: abnormal), a system administrator checks whether such mismatch data can be corrected (S16). A technique such as deep learning may be used instead of the system administrator.

If the correction is possible, the data T3, obtained by associating data whose facility name or address has been corrected with the service usage amount, is registered in the data storage unit 33 (S17).

The data provision unit 36 transmits the second service management data T3 for which the collation with the first service management data T1 has been completed and an analysis result thereof to the service user 2 (S18). Examples of the data analysis include transition of an actual service usage amount, a comparison of a service usage amount with that of the same period in the previous year, prediction of a future service usage amount, proposal for review of the content of a contract, and the like.

On the other hand, if it is determined that the mismatch data is uncorrectable, the data provision unit 36 creates an abnormality list (S19). The abnormality list is a list indicating that the collation result is the mismatch, and thus, can also be referred to as collation result mismatch data. The data provision unit 36 transmits the abnormality list, which is a list of pieces of the mismatch data, to the service user 2 (S20).

As a cause of generation of abnormal data with a mismatch facility name or address, there is a case where a facility whose contract has been terminated for the service user 2 is still registered in the service provider 1.

When the number of facilities managed by the service user 2 is large and contract renewal or the like with the facilities frequently occurs, there may be a case where a facility out of management due to the termination of the contract remains as data on the service provider 1 side. Further, even if an actual power consumption is zero, a monthly usage fee is charged for an advertisement lighting device or the like installed at a place distant from a facility. For example, it is easy to miss a power-consuming device such as the advertisement lighting device installed at the place distant from the closed facility.

If the association unit 34 determines that the facility name and address match (S15: normal), the data inspection unit 35 checks whether the service usage amount is appropriate (S21). For example, the data inspection unit 35 can determine whether the service usage amount of this month is appropriate from a comparison with the same month in the previous year or a comparison with the previous month. Alternatively, the data inspection unit 35 can also determine whether the service usage amount of this month is appropriate from a comparison with a service usage amount in another facility in the same area or a service usage amount in another facility having similar installation area or facility.

If the inspection result of the data inspection unit 35 is normal (S21: normal), data in which the facility name and address match and the service usage amount is also appropriate is registered in the data storage unit 33 (S17). Then, the data and the analysis result are transmitted from the data provision unit 36 to the service user 2 (S18).

If the inspection result of the data inspection unit 35 is abnormal (S21: abnormal), the data inspection unit 35 creates an abnormality list (S22). The created abnormality list is transmitted from the data provision unit 36 to the service user 2 (S23).

The abnormality list created in step S22 is a list for notifying the service user 2 of an abnormality in the service usage amount. Therefore, this abnormality list can also be referred to as a service usage amount abnormality list or service usage amount abnormality data. Further, the abnormality list can include not only an abnormal state of the service usage amount but also advice on such an abnormality. Examples of the advice include a possibility of electric leakage of an electric device, a possibility of failure or deterioration, and a possibility of an error of the service provider 1.

### Second Embodiment

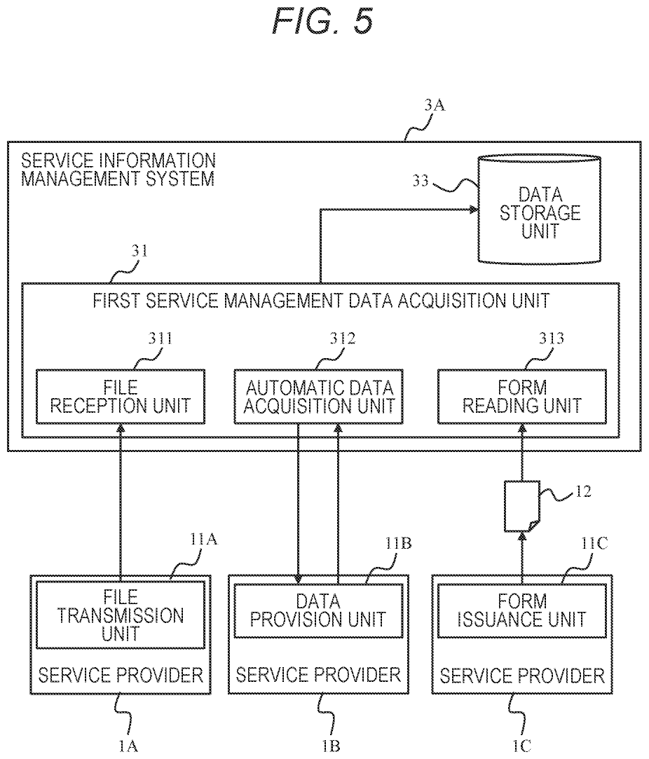

A second embodiment will be described with reference to FIG. 5. Differences from the first embodiment will be mainly described in each of the following embodiments including the present embodiment. A service information management system 3A of the present embodiment can acquire the first service management data T1 from each of service providers 1A, 1B, and 1C by different methods.

FIG. 5 is an explanatory diagram illustrating extracted main parts of the service information management system 3A. The first service management data acquisition unit 31 includes a file reception unit 311, an automatic data acquisition unit 312, and a form reading unit 313 as data acquisition means.

In the example of FIG. 5, a first service management data management unit 11A of the service provider 1A includes a file transmission unit that transmits the first service management data T1 to the service information management system 3A. A first service management data management unit 11B of the service provider 1B includes a data provision unit that provides the first T1 through a website of the service provider 1B. A first service management data management unit 11C of the service provider 1C includes a form issuance unit 11C that issues a form 12 of a paper medium.

The file reception unit 311 receives an electronic file of the first service management data T1 transmitted from the service provider 1A, and registers the electronic file in the data storage unit 33. The automatic data acquisition unit 312 logs in to a data provision service of the web site of the service provider 1B, reads out the first service management data T1, and registers the read-out first service management data T1 in the data storage unit 33. The form reading unit 313 reads the form 12 issued from the service provider 1C as electronic data by an OCR or the like, and registers the first service management data T1 read from the form 12 in the data storage unit 33.

The present embodiment configured in this manner also has the same operation and effect as the first embodiment. Since the first service management data T1 can be acquired in accordance with each of the service providers 1A to 1C in the present embodiment, it is possible to support more service providers 1. Note that one service provider 1 may provide the first service management data T1 to the service information management system 3A by a plurality of methods.

### Third Embodiment

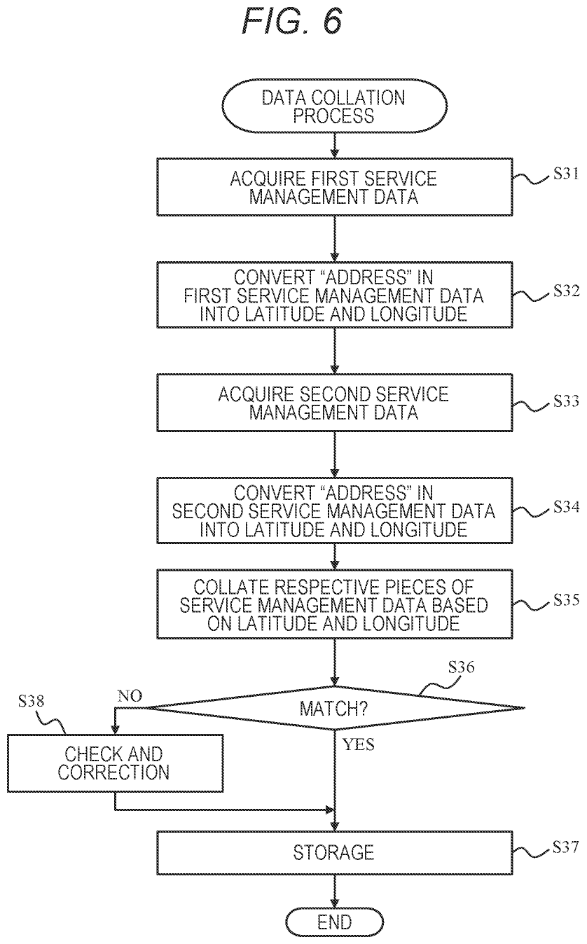

A third embodiment will be described with reference to FIG. 6. FIG. 6 is a flowchart illustrating a data collation process performed by the service information management system 3 of the present embodiment.

The association unit 34 acquires the first service management data T1 from the data storage unit 33 (S31), and converts an address in the acquired first service management data T1 into latitude and longitude (S32). Similarly to the above, the association unit 34 acquires the second service management data T2 from the data storage unit 33 (S33), and converts an address in the acquired second service management data T2 into latitude and longitude (S34).

The association unit 34 compares and collates the latitude and longitude obtained from the address of the first service management data T1 with movement longitude obtained from the address of the second service management data T2 (S35), and determines whether the both match each other (S36).

If values of the latitude and longitude of the both match each other (S36: YES), the association unit 34 stores the first service management data T1 acquired in step S31 and the second service management data T2 acquired in step S33 in the data storage unit 33 in association with each other (S37).

On the other hand, if the values of the latitude and longitude of the both do not match each other (S36: NO), the association unit 34 confirms a difference by a system administrator or a technique such as deep learning, and corrects the difference when the difference is correctable (S38). The corrected data is stored in the data storage unit 33. When the correction is not possible, such data is written in the abnormality list and provided to the service user 2.

The present embodiment configured in this manner also has the same operation and effect as the first embodiment.

### Fourth Embodiment

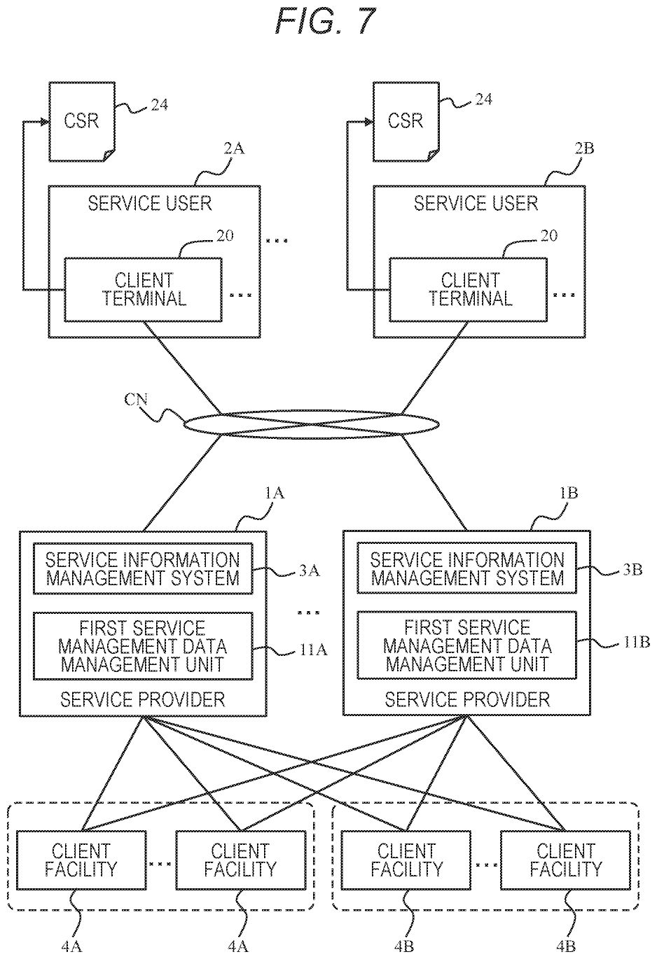

A fourth embodiment will be described with reference to FIG. 7. In the present embodiment, the service information management systems 3A and 3B are provided inside the service providers 1A and 1B, respectively. The service provider 1A includes the service information management system 3A, and the service provider 1B includes the service information management system 3B.

The service provider 1A associates the first service management data T1 managed by the own company with the second service management data T2 of the service user 2A as a customer. Similarly, the service provider 1B associates the first service management data T1 managed by the own company with the second service management data T2 of the service user 2B as a customer.

The present embodiment configured in this manner also has the same operation and effect as the first embodiment. Further, the quality of services provided by the service providers 1A and 1B to the service users 2A and 2B can be improved in the present embodiment.

### Fifth Embodiment

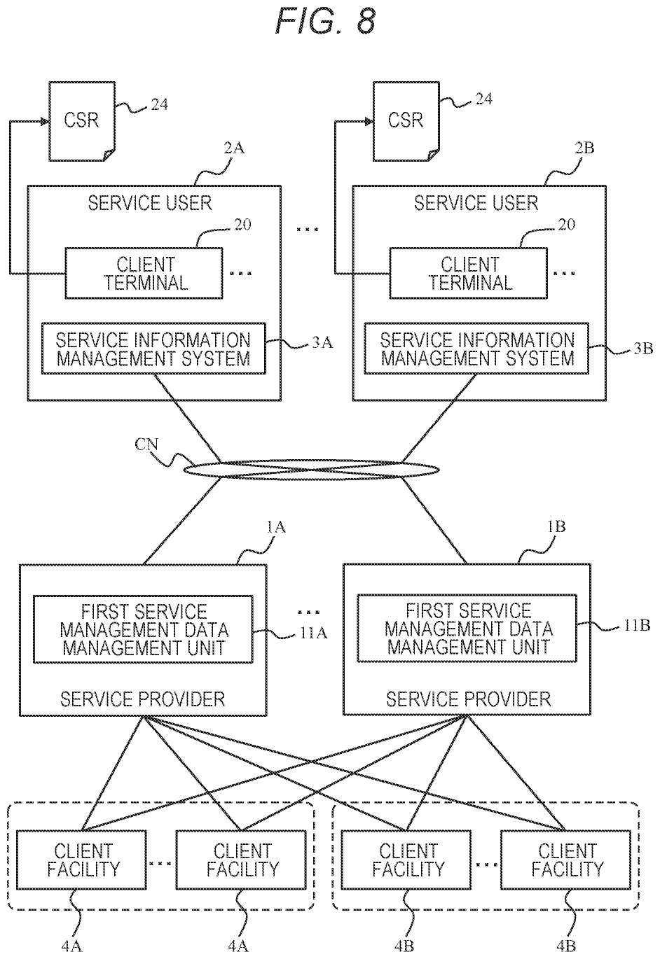

A fifth embodiment will be described with reference to FIG. 8. In the present embodiment, the service information management systems 3A and 3BD are provided inside the service users 2A and 2B, respectively. That is, the service user 2A includes the service information management system 3A and stores the first service management data T1 from the service provider 1A in association with the second service management data T2 managed by the own company. Similarly, the service user 2B includes the service information management system 3B and stores the first service management data T1 from the service provider 1B in association with the second service management data T2 managed by the own company.

The present embodiment configured in this manner also has the same operation and effect as the first embodiment. Further, the first service management data T1 and the second service management data T2 can be associated with each other inside each of the service users 2A and 2B in the present embodiment.

Note that the present invention is not limited to the above-described embodiments. Any person skilled in the art can make various additions and changes within a scope of the present invention. The present invention is not limited to the configuration examples illustrated in the accompanying drawings in the above-described embodiments. The configurations and processing methods of the embodiments can be changed as appropriate within the scope of achieving the object of the present invention.

In addition, each component of the present invention can be arbitrarily selected, and an invention having a selected configuration is also included in the present invention. Further, the configurations described in the claims can be combined in combinations other than those specified in the claims.

### REFERENCE SIGNS LIST

1, 1A, 1B service provider
2, 2A, 2B service user
3, 3A service information management system
4 facility
11 first service management data management unit
21 data registration unit
22 display unit
23 data utilization unit
31 first service management data acquisition unit
32 second service management data acquisition unit
33 data storage unit
34 association unit
35 data inspection unit
36 data utilization unit
37 data provision unit
T1 first service management data
T2 second service management data
T3 data for which association processing has been completed

1. A service information management system that manages information on a service provided from a service provider to a service user, the service information management system comprising:
a first service management data acquisition unit that acquires first service management data for managing a service usage state for each facility of the service user, the first service management data being managed by a computer of the service provider;
a second service management data acquisition unit that acquires second service management data storing a service usage state for each facility, the second service management data being managed by a computer of the service user;
an association unit that collates the first service management data with the second service management data to associate the service usage state included in the first service management data with facility identification information included in the second service management data; and
a data provision unit that provides data obtained by association of the association unit to the computer of the service user.

2. The service information management system according to claim 1, further comprising an inspection unit that inspects presence or absence of a predetermined abnormality for the first service management data acquired by the first service management data acquisition unit.

3. The service information management system according to claim 2, wherein the data provision unit provides an inspection result of the inspection unit to the computer of the service user.

4. The service information management system according to claim 1, wherein the first service management data acquisition unit acquires the first service management data from the computer of the service provider by a plurality of different methods.

5. The service information management system according to claim 3, wherein the inspection unit inspects the first service management data for a facility out of management of the service user as the predetermined abnormality.

6. The service information management system according to claim 3, wherein the inspection unit inspects the first service management data for a power-consuming device installed away from the facility as the predetermined abnormality.

7. The service information management system according to claim 3, wherein the inspection unit determines a possibility that a power-consuming device included in a facility has failed or a possibility that the service provider has made an error in creating the first service management data based on the inspection result.

8. A service information management method for managing, by a computer, information on a service provided from a service provider to a service user, the service information management method comprising:
acquiring, by the computer, first service management data for managing a service usage state for each facility of the service user, the first service management data being managed by a computer of the service provider;
acquiring, by the computer, second service management data storing a service usage state for each facility, the second service management data being managed by a computer of the service user;
collating, by the computer, the first service management data with the second service management data to associate the service usage state included in the first service management data with a facility identifier included in the second service management data; and
providing, by the computer, data obtained by association to the computer of the service user.
